(19) United States
(12) Patent Application Publication
(10) Pub. No.: US 2019/0217761 A1
(43) Pub. Date: Jul. 18, 2019

(54) ARMREST ARRANGEMENT FOR A VEHICLE INTERIOR

(71) Applicants: Jan BODDENBERG, Koln (DE); Hartmut BOHLKE, Wuppertal (DE); Andreas GÖBBELS, Kurten (DE); Tanja PINK, Wuppertal (DE); Wolfgang SITZLER, Wuppertal (DE); Bogdan TUTELEA, Leichlingen (DE)

(72) Inventors: Jan BODDENBERG, Koln (DE); Hartmut BOHLKE, Wuppertal (DE); Andreas GÖBBELS, Kurten (DE); Tanja PINK, Wuppertal (DE); Wolfgang SITZLER, Wuppertal (DE); Bogdan TUTELEA, Leichlingen (DE)

(21) Appl. No.: 16/247,978

(22) Filed: Jan. 15, 2019

(30) Foreign Application Priority Data
Jan. 16, 2018 (DE) 10 2018 200 624.5

(51) Int. Cl. B60N 2/75; B60N 3/10

(52) U.S. Cl. CPC B60N 2/793; B60N 3/102

(57) ABSTRACT

Armrest arrangement for a vehicle interior having an armrest, a container-receiving device which is provided for receiving a container and arranged at least partially in a cavity of the armrest, and a guide device by which the container-receiving device is guided relative to the cavity along a pull-out direction between a retracted inoperative position and an extended receiving position. The guide device is formed on a rest carrier structure which is provided for supporting the armrest and mounted securely on the vehicle in the assembled state.

### CROSS-REFERENCE TO RELATED APPLICATIONS

This claims priority from German Application No. 2018 200 624.5, filed Jan. 16, 2018, the disclosure of which is hereby incorporated by reference in its entirety.

### RELATED FIELD

The invention relates to an armrest arrangement for a vehicle interior having an armrest, a container-receiving device which is provided for receiving a container and arranged at least partially in a cavity of the armrest, and a guide device by means of which the container-receiving device is guided relative to the cavity along a pull-out direction between a retracted inoperative position and an extended receiving position.

### BACKGROUND

An armrest arrangement of such type is known from DE 10 2014 217 107 A1 and provided for mounting in the region of a rear seat bench of a passenger car. The known armrest arrangement has an armrest and a container-receiving device which is arranged at least partially in a cavity of the armrest. The container-receiving device is displaceable by means of a guide device along a pull-out direction between a receiving position in which it is extended from the cavity and an inoperative position in which it is retracted into the cavity in a substantially flush manner. In the case of the known armrest arrangement, the guide device is formed in a cassette-like receiving housing. The container-receiving device is inserted into the receiving housing and can be displaced in a guided manner on its guide device. The receiving housing is in turn inserted into the cavity of the armrest and arrested therein.

### SUMMARY

The object of the invention is to provide an armrest arrangement of the type stated at the outset which has a structural design which is simplified by comparison with the prior art and in particular allows a saving of installation space.

This object is achieved in that the guide device is formed on a rest carrier structure which is provided for supporting the armrest and mounted securely on the vehicle in the assembled state. The solution according to the invention makes it possible in particular to dispense with a separate receiving housing. Instead, the guide device is formed on the rest carrier structure and the container-receiving device is in this respect formed without a housing. This allows a simplified structural design of the armrest arrangement and in particular a reduced number of components and a saving of installation space. This in turn allows a simplified and hence cost-reduced production of the armrest arrangement. In addition, a simplified assembly of the armrest arrangement can be achieved. The rest carrier structure serves for mechanically reinforcing the armrest. The rest carrier structure is preferably arranged as an inner structure and in this respect arranged in the interior of the armrest. The rest carrier structure can be produced for example from plastic in the form of an injection-molded component or from metal in the form of a joined frame structure, welded structure, cast structure or sheet metal structure. The rest carrier structure is preferably mounted securely on the vehicle so as to be pivotable in an assembled state, with the result that the armrest is displaceable for example between a supporting position and a non-use position by means of pivoting the rest carrier structure. In the supporting position, the armrest is oriented preferably parallel to a longitudinal direction of the vehicle interior and thus oriented substantially horizontally. In the non-use position, the armrest is preferably oriented parallel to a height direction of the vehicle interior and thus oriented substantially vertically. The guide device serves for guiding the container-receiving device during a displacement between the inoperative and the receiving position. The guide device can be configured in such a way that the container-receiving device is displaceable with guidance in a linearly movable and/or pivotably movable manner. The guide device is preferably a sliding guide device by means of which the container-receiving device is supported in a sliding manner during a displacement. With the armrest arrangement in a state in which it is assembled as intended, the pull-out direction is oriented preferably parallel to the longitudinal direction of the vehicle interior. The container-receiving device is preferably designed in the form of a drinks holder. The container-receiving device can have a supporting frame which is provided in the receiving position for supporting a drinks container laterally and/or on its bottom side. For alternative or additional support of a container on its bottom side, the container-receiving device can have a carrier base which can be mounted pivotably relative to the supporting frame by means of a pivoting kinematic mechanism.

The solution according to the invention is suitable in a particularly preferred manner for use in the region of a rear seat bench of a passenger car and can thus be configured as a central armrest arrangement. However, the solution according to the invention can also be used in the region of a driver's or front passenger's seat and can in this respect be designed in the form of a driver's or front passenger's armrest arrangement.

In an embodiment of the invention, the guide device is a linear guide device by means of which the container-receiving device is guided in a linearly movable manner. The container-receiving device can be guided by means of the linear guide device such that it can be extended from and retracted into the cavity in the manner of a drawer. Particularly in relation to a comparatively space-consuming pivoting guide device, this embodiment of the invention additionally makes it possible to save on installation space.

In a further embodiment of the invention, the guide device has at least one guide rod which is fastened to the rest carrier structure and on which a guide carriage of the container-receiving device is supported in a linearly displaceable manner. The guide rod is preferably fastened to the rest carrier structure in a form-fitting manner and can in this respect be plugged for example into corresponding receiving openings of the rest carrier structure. Alternatively or in addition, the guide rod can be connected to the rest carrier structure in a force-fitting and/or integrally bonded manner. The guide carriage is preferably supported in a sliding manner on the guide rod in the pull-out direction.

In a further embodiment of the invention, a drive device which is supported on the rest carrier structure is provided by means of which the container-receiving device is displaceable in a driven manner at least from the operative position into the receiving position. The drive device preferably has a mechanical spring drive which is configured in such a way that the container-receiving device is displaceable in a driven manner from the inoperative position into the receiving position under spring force loading. In addition, the drive device can be configured in such a way that the container-receiving device is additionally displaceable in a driven manner from the receiving position into the inoperative position.

In a further embodiment of the invention, the drive device has a rack drive having a drive shaft, at least one drive pinion and at least one rack. The rack is preferably longitudinally extended in the pull-out direction and fixedly connected to the rest carrier structure. The drive shaft is preferably rotatably mounted on the container-receiving device and longitudinally extended transversely to the pull-out direction. The drive pinion is fastened on the drive shaft in a rotationally fixed manner and is in engagement with the rack. The drive shaft is preferably subjected to torque by means of a coil spring of a spring drive, which spring is configured and/or arranged in such a way that the container-receiving device is displaceable from the inoperative position into the receiving position under spring force driving. The drive device thus formed allows particularly robust driving of the container-receiving device.

In a further embodiment of the invention, a damping device which is supported on the rest carrier structure is provided by means of which a displacement speed of the container-receiving device along the pull-out direction is damped. The damping device can counteract displacement of the container-receiving device from the inoperative position into the receiving position, or vice versa. Accordingly, the damping device can be a single-acting damping device. Alternatively, the damping device can be double-acting and thus counteract both a displacement into the inoperative position and a displacement into the receiving position. The speed of the displacement of the container-receiving device that is slowed in this manner makes it possible to achieve improved handling and in addition an improved quality impression of the armrest arrangement.

In a further embodiment of the invention, the damping device has a rotation damper which is supported at least indirectly on a rack. The rotation damper is preferably designed in the form of a silicone brake. Silicone brakes are known in principle in the field of motor vehicle technology. The rotation damper is supported on the rack by means of a pinion. The rack is preferably fixedly connected to the rest carrier structure.

The rotation damper is preferably rotatably mounted on the container-receiving device.

In a further embodiment of the invention, the rotation damper is arranged concentrically on the drive shaft of the drive device and causes damping of a rotational speed of the drive shaft. This is a particularly installation space-saving embodiment of the invention.

In a further embodiment of the invention, the guide device has at least one tolerance-compensating element by means of which the container-receiving device is elastically supported at least indirectly on the rest carrier structure transversely to the pull-out direction. The at least one tolerance-compensating element serves for compensating for manufacturing- and/or assembly-related tolerances of the guide device and/or of the rest carrier structure. Since the container-receiving device is elastically supported transversely to the pull-out direction by means of the tolerance-compensating element, jamming of the container-receiving device during a displacement between the inoperative position and the receiving position can be avoided. Provided that the guide device has at least one guide rod, it is advantageous if the tolerance-compensating element produces a mounting of the guide rod on the rest carrier structure that is elastic transversely to the pull-out direction. The tolerance-compensating element is preferably configured to be soft elastic. For this purpose, the tolerance-compensating element can be produced from a soft elastic material. Alternatively or in addition, the tolerance-compensating element can have an elastically flexible design, with the result that the elastic flexibility can be structure-related.

In a further embodiment of the invention, the tolerance-compensating element is produced from plastic and designed in the form of a soft elastic ring. The soft elastic configuration of the ring can be material- and/or design-related. Provided that the guide device has at least one guide rod, the soft elastic ring preferably serves for elastically mounting the guide rod on the rest carrier structure. For this purpose, it is advantageous if the soft elastic ring is arranged on an end face of the guide rod and engages around the latter in the circumferential direction. With particular preference, two soft elastic rings are arranged on opposite end face regions of the guide rod. The soft elastic ring can be produced for example from a PU soft foam. Alternatively, the ring can be produced from a rubber-elastic material. The soft elastic ring can for example be designed in the form of a perforated circular disk, an annular membrane which has one or more bulges in the axial direction or in the manner of a spoked wheel.

### BRIEF DESCRIPTION OF THE DRAWINGS

Further advantages and features of the invention will emerge from the claims and from the following description of preferred exemplary embodiments of the invention which are illustrated by way of the drawings.

FIG. 1 shows in a schematic perspective illustration an embodiment of an armrest arrangement according to the invention which is assigned to a rear seat bench and has a container-receiving device which assumes an inoperative position,

FIG. 2 shows the armrest arrangement according to FIG. 1, wherein the container-receiving device assumes a receiving position,

FIG. 3 shows in a partially cut-away perspective exploded illustration the armrest arrangement according to FIGS. 1 and 2,

FIG. 4 shows in a partially cut-away schematic perspective illustration the armrest arrangement according to FIGS. 1 to 3 in the receiving position with the omission of individual components,

FIGS. 5 and 6 each show in a partially cut-away schematic plan view, with the omission of individual components, the armrest arrangement according to FIGS. 1 to 4 in the inoperative position (FIG. 5) and the receiving position (FIG. 6),

FIG. 7 shows in a view corresponding to FIG. 5 a further embodiment of an armrest arrangement according to the invention,

FIG. 8 shows in an enlarged detail illustration a region B of the armrest arrangement according to FIG. 7,

FIG. 9 shows in a partially cut-away schematic perspective illustration, with the omission of individual components, a further embodiment of an armrest arrangement according to the invention,

FIG. 10 shows a further schematic perspective illustration of the armrest arrangement according to FIG. 9, wherein the illustration is partially cut open in the region of a drive device,

FIG. 11 shows in a schematic detail illustration a tolerance-compensating element of the armrest arrangement according to FIGS. 9 and 10, and

FIGS. 12 and 13 show in a partially cut-open perspective illustration a first embodiment variant (FIG. 12) and in a schematic view a second embodiment variant (FIG. 13) of the tolerance-compensating element according to FIG. 11.

### DETAILED DESCRIPTION

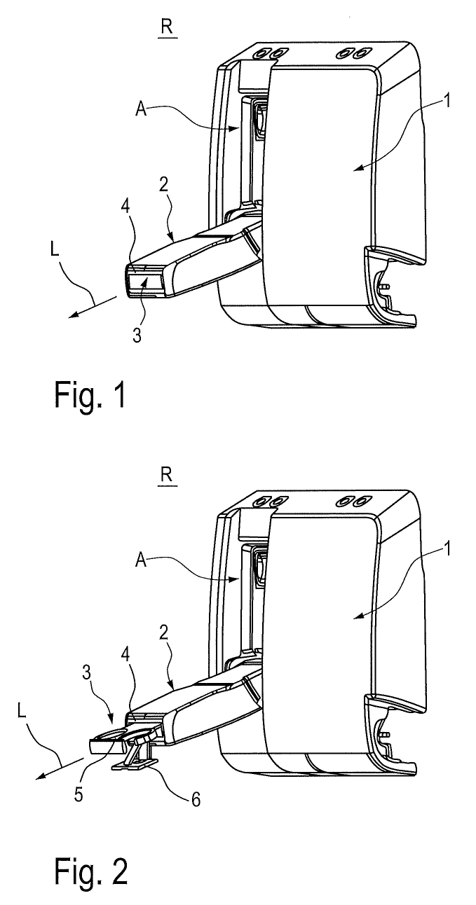

According to FIGS. 1 and 2, a vehicle interior R of a passenger car has a rear seat bench 1 of which only part of a backrest arrangement is illustrated for reasons of clarity. The backrest arrangement of the rear seat bench 1 has an armrest arrangement 2. The armrest arrangement 2 is mounted pivotably relative to the backrest arrangement of the rear seat bench 1 and is displaceable between a supporting position and a non-use position. In the supporting position illustrated by way of FIGS. 1 and 2, the armrest arrangement 2 is pivoted forward and downward relative to the backrest arrangement into an approximately horizontal position in which the armrest arrangement 2 is held in a stable manner by corresponding stops. In the non-use position (not illustrated in further detail), the armrest arrangement 2 is pivoted rearward and upward relative to the backrest arrangement of the rear seat bench 1 into an approximately vertical position. In the last-mentioned position, the armrest arrangement 2 is sunk in a recess A of the rear seat bench 1 and terminates substantially flush with a surface of the backrest arrangement.

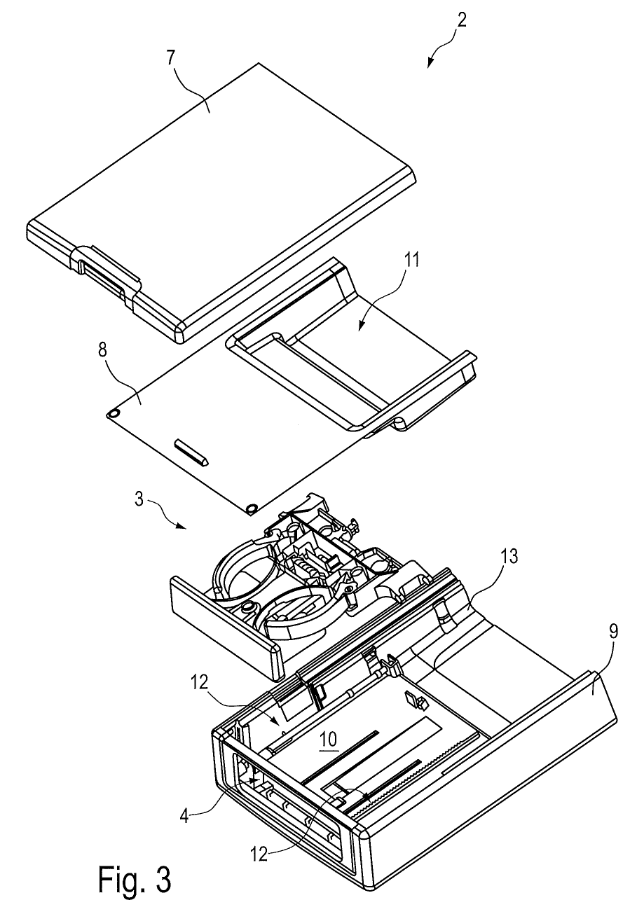

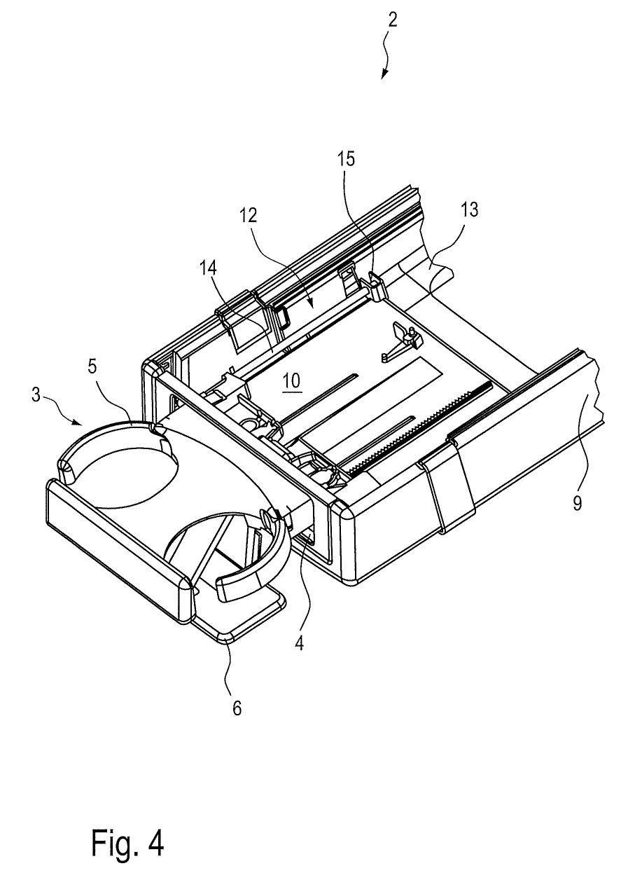

As is further visible particularly by way of FIG. 3, the armrest arrangement 2 has an armrest 7, 8, 9. In the present case, the armrest 7, 8, 9 has a base housing 9, an intermediate plate 8 and a cover plate 7. The base housing 9 is designed to be substantially parallelepipedal and has a cavity 10 which is accessible through a front end opening 4. In the assembled state, the intermediate plate 8 is placed on the upper side of the base housing 9 and connected fixedly thereto. In a rear region which faces away from the front end opening 4, the intermediate plate 8 has a trough-shaped depression 11 which serves for example as a storage compartment for small objects. In the assembled state, the cover plate 7 lies at least partially flat on the intermediate plate 8 and, in a manner which cannot be seen in further detail, is articulated so as to be pivotable relative thereto and to the base body 9 between an open and a closed position. In the closed position, as is visible by way of FIGS. 1 and 2, the cover plate 7 lies flat on the intermediate plate 8 and the base housing 9 and serves for example as a supporting or arm-bearing surface. In the open position (not illustrated in further detail), the cover plate 7 is pivoted upwardly and rearwardly relative to the intermediate plate 8 and oriented substantially vertically. In this position, the cover plate 7 releases the receiving compartment formed by means of the trough-shaped depression 11.

Furthermore, the armrest arrangement 2 has a container-receiving device 3 which is provided for receiving at least one container and is arranged at least partially in the cavity 10 of the armrest 7, 8, 9. In the assembled state, the container-receiving device 3 is inserted through the front end opening 4 into the cavity 10 and, in a manner which is still to be described in further detail, is displaceable along a pull-out direction L between a retracted inoperative position (FIG. 1) and an extended receiving position (FIG. 2).

In the present case, the container-receiving device 3 has a supporting frame 5 and a carrier base 6, although this does not necessarily have to be the case. The supporting frame 5 serves in particular for laterally supporting a container received in the container-receiving device 3, such as for example a drinks can or the like. By contrast, the carrier base serves for supporting the container on its bottom side. The supporting frame 5 is provided at its end side with a cover (not designated in further detail) which produces a visually flush termination of the container-receiving device 3 in the region of the front end side of the base housing 9 as soon as the container-receiving device 3 is transferred into the retracted inoperative position (FIG. 1). In the extended receiving position, the supporting frame 5 and the carrier base 6 are displaced forward relative to the cavity 10, wherein the carrier base 6 is additionally pivoted downward relative to the supporting frame 5 by means of a pivoting kinematic mechanism (FIG. 2).

In order to displace the container-receiving device 3, a guide device 12 is provided. By means of the guide device 12, the container-receiving device 3 is displaceable in a guided manner relative to the cavity 10 along the pull-out direction L between the retracted inoperative position and the extended receiving position. The guide device 12 is formed on a rest carrier structure 13. The rest carrier structure 13 is provided for supporting the armrest 7, 8, 9 and mounted securely on the vehicle in the assembled state. The rest carrier structure 13 thus forms a mechanical reinforcement of the armrest 7, 8, 9 and in the present case particularly produces a stiffening of the base housing 9. The rest carrier structure 13 can be produced from metal and be designed in the form of a sheet metal construction. Alternatively, it is also possible for the rest carrier structure 13 to be produced from a sufficiently stiff plastic. At an end face facing away from the front end opening 4, the rest carrier structure 13 is provided with a pivot bearing (not illustrated in further detail) which can be supported on a supporting construction of the rear seat bench 1. By means of the pivot bearing arrangement of this type, the rest carrier structure 13 and hence the entire armrest arrangement 2 is pivotable between the supporting position which can be seen by way of FIGS. 1 and 2 and the upwardly pivoted non-use position (not illustrated in further detail).

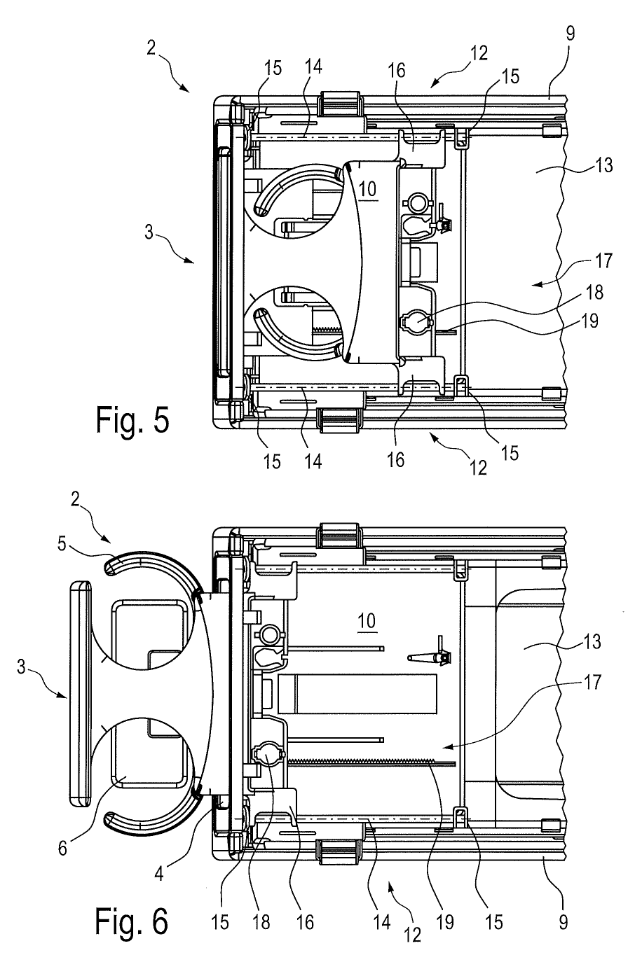

As is visible particularly by way of FIGS. 5 and 6, the armrest arrangement 2 is in the present case designed to be substantially mirror-symmetrical to a center longitudinal plane (not designated in further detail), although this is not absolutely necessary. In this respect, two guide devices 12 arranged on lateral regions opposite to one another in the transverse direction are formed on the rest carrier structure 13 in the present case. This is in turn not absolutely necessary, but ensures an advantageous guidance of the container-receiving device 3 that respects tolerances particularly in the transverse direction. Insofar as only one of the two guide devices 12 is discussed in further detail below, the disclosure in this respect correspondingly applies to the other of the guide devices.

In the present case, the guide device 12 is a linear guide device by means of which the container-receiving device 3 is displaceable in a linearly movable manner along the pull-out direction L. For this purpose, the guide device 12 has at least one guide rod 14 which is fastened to the rest carrier structure 13. The guide rod 14 is oriented parallel to the pull-out direction L and received at mutually opposite end face regions in a respective retaining portion 15 of the rest carrier structure 13. In the present case, the retaining portions 15 are formed in one piece on the rest carrier structure 13. The guide rod 14 is plugged in a form-fitting manner at its end faces into in each case one of the retaining portions 15. Instead, the guide rod 14 can also be formed in one piece with the rest carrier structure 13 or be connected thereto in a force-fitting and/or form-fitting manner. The container-receiving device 3 has two guide carriages 16 arranged oppositely in the transverse direction. The guide carriages 16 are each supported in a linearly displaceable manner so as to slide in each case on one of the guide rods 14. In the inoperative position of the container-receiving device 3 that can be seen from FIG. 5, the guide carriages each assume a rear end position. By contrast, in the receiving position (FIG. 6), the guide carriages 16 assume a front end position in the region of the front end opening 4 of the base housing 9.

In order to damp a displacement speed of the container-receiving device 3 along the pull-out direction L, a damping device 17 is provided. The damping device 17 is supported on the rest carrier structure 13. At any rate individual components of the damping device 17 are formed on the rest carrier structure 13. Thus, in the present case, the damping device 17 has a rotation damper 18 and a rack 19. In the present case, the rotation damper 18 is a silicone brake. Silicone brakes are known in principle in the field of motor vehicle technology. In a lower region—with respect to the drawing plane of FIGS. 5 and 6—of the container-receiving device 3, the silicone brake 18 is arranged so as to adjoin the lower guide carriage 16. The silicone brake 18 has a pinion (not visible in further detail) which is in engagement with the rack 19 which is formed on the rest carrier structure 13. The rack 19 is oriented parallel to the pull-out direction L. The axis of rotation of the pinion of the silicone brake 18 is oriented transversely to the pull-out direction L and in the height direction. In the present case, the damping device 17 is designed to be double-acting insofar as it counteracts a movement of the container-receiving device 3 both in the direction of the inoperative position and in the direction of the receiving position. The damping device 17 thus causes a deceleration of the displacement speed of the container-receiving device 3, whereby a jolting motion sequence during the displacement between the inoperative position and the receiving position is avoided. As a result, improved ease of handling and an enhanced quality impression are achieved.

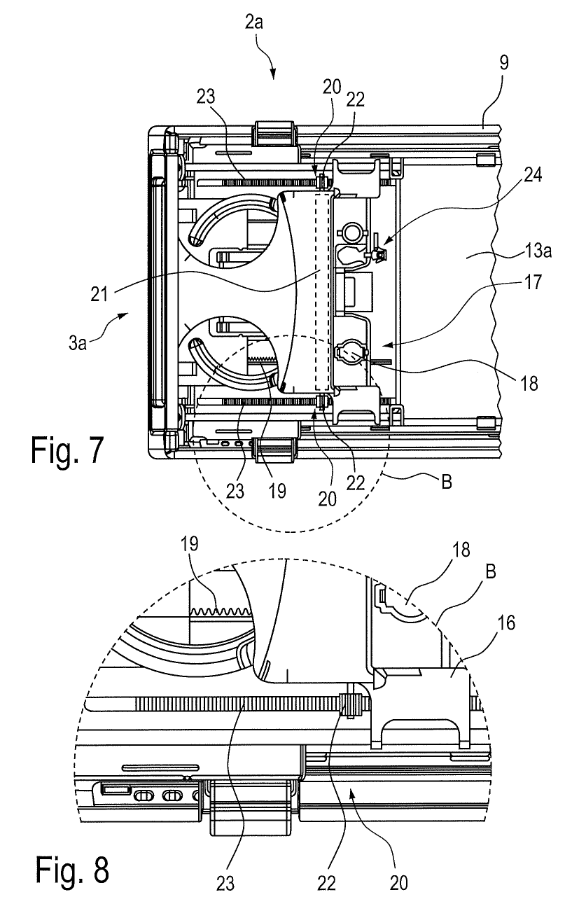

FIGS. 7, 8 and 9, 10 reveal further embodiments of armrest arrangements 2a and 2b according to the invention. In terms of their structural and functional features, the armrest arrangements 2a, 2b have a design which corresponds substantially with the armrest arrangement 2. To avoid repetitions, only essential differences of the armrest arrangements 2a, 2b in relation to the armrest arrangement 2 will therefore be discussed below. With respect to structurally and/or functionally corresponding features, reference is made to the disclosure in conjunction with the armrest arrangement 2, which applies in a corresponding manner to the armrest arrangements 2a, 2b. In this respect, components and portions which are identical in the armrest arrangements 2 to 2b are provided with identical reference signs. Functionally equivalent components and/or portions which differ, however, in their structural design are designated by identical reference sign numbers with the addition of lower-case letters.

The armrest arrangement 2a differs substantially from the armrest arrangement 2 in that a drive device 20 is provided by means of which the container-receiving device 3a is displaceable in a driven manner at least from the inoperative position into the receiving position. In the present case, by virtue of the above-described mirror-symmetrical configuration of the armrest arrangement 2a, two drive devices 20 are provided which are arranged on lateral regions of the container-receiving device 3a which are opposite in the transverse direction. However, this is not absolutely necessary. Instead, only one drive device 20 can also be provided. The drive devices 20 each have a rack drive 21, 22, 23. In the present case, the rack drive 21, 22, 23 has two racks 23 which extend parallel to one another. The racks 23 are supported in each case on the rest carrier structure 13 and connected fixedly thereto. The racks 23 can, for example, be formed in one piece on the rest carrier structure 13a. Alternatively, the racks 23 can each be connected to the rest carrier structure 13a in a force-fitting, form-fitting and/or integrally bonded manner. Furthermore, each drive device 20 has a drive pinion 22 which is in operative connection with in each case one of the racks 23. In the present case, the drive pinions 22 are mounted on a common drive shaft 21 in a rotationally fixed manner. For reasons of clarity, the drive shaft 21 is illustrated by way of FIG. 7 only in dashed lines. The drive shaft 21 is oriented transversely and horizontally to the pull-out direction L and mounted rotatably in a portion of the container-receiving device 3a that adjoins the guide carriages 16. The drive devices 20 are additionally assigned a motor unit (not visible in further detail) in the form of a spring motor which is known in principle. The spring motor can have a winding shaft by means of which the common drive shaft 21 is subjected to torque in such a way as to allow a driven displaceability of the container-receiving device 3a starting from the inoperative position (FIG. 7) into the extended receiving position. In order to secure the container-receiving device 3a in the inoperative position counter to the driving force of the drive devices 20 produced in this way, an arresting device 24 is provided in the present case. The arresting device is designed in the form of a positively acting latching device. The arresting device 24 can be releasable for example by means of manually pressing the container-receiving device 3a into the front end opening 4.

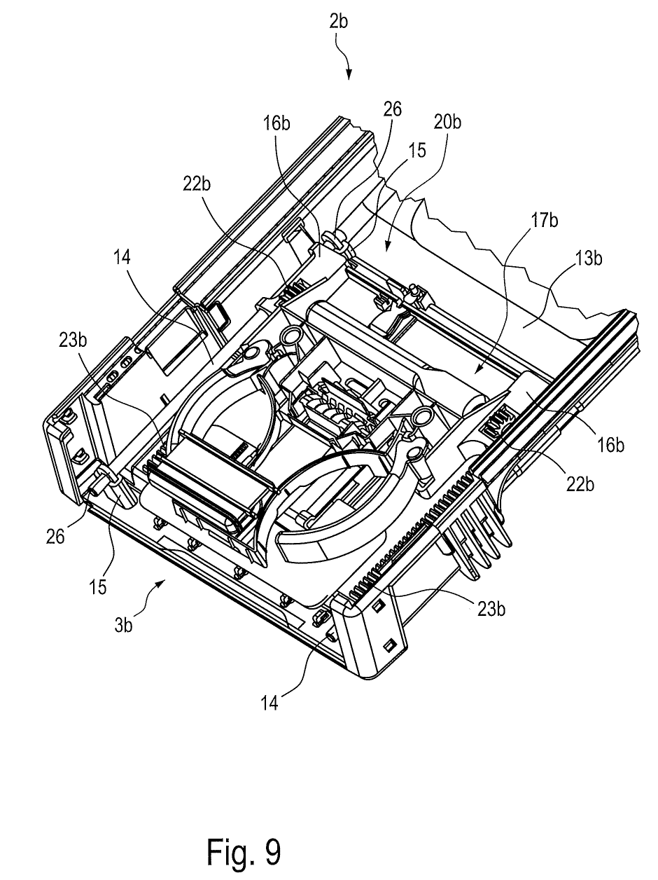

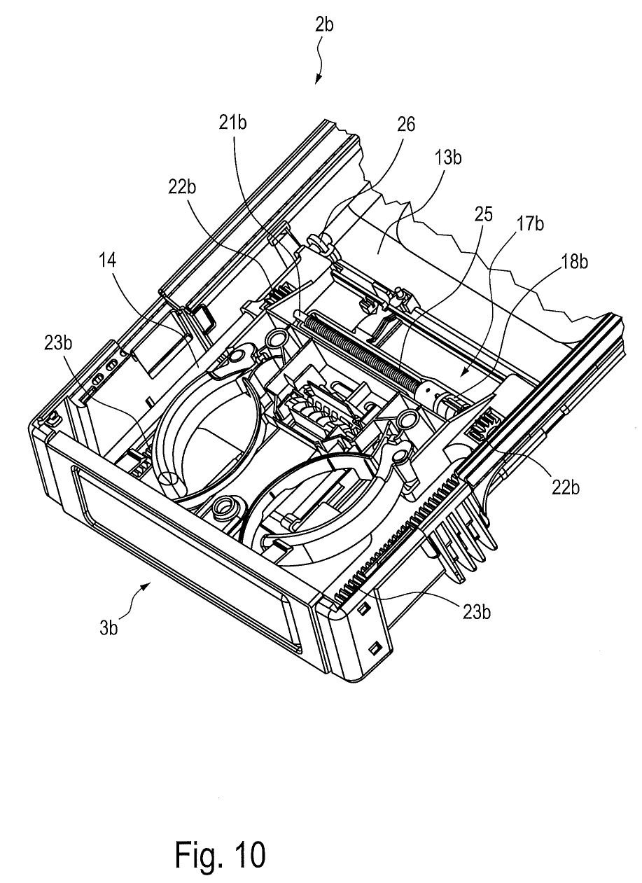

The armrest arrangement 2b according to FIGS. 9, 10 differs substantially from the armrest arrangements 2, 2a in that a different design of the drive device 20b there and of the damping device 17b there is provided. The drive device 20b has a rack drive which is built up substantially symmetrically to a center longitudinal plane, said drive having a common drive shaft 21b, two drive pinions 22b arranged on opposite end face regions of the drive shaft 21b, and two racks 23b extending in parallel and arranged oppositely in the transverse direction. The partially cut-open illustration of FIG. 10 reveals further details of the drive device 20b and of the damping device 17b. Thus, the drive device 20b has a coil spring 25 which is secured on an outer circumference of the drive shaft 21b. The coil spring 25 is supported at one end so as to be fixed in terms of torque with the drive shaft 21b and supported at the other end so as to be fixed in terms of torque on a supporting portion (not visible in further detail) of the container-receiving device 3b. In this way, the coil spring 25, when in a twisted state, provides an application of torque to the drive shaft 21b. This application of torque can be converted by means of the drive pinions 22b and the racks 23b into a displacement movement of the container-receiving device 3b along the pull-out direction L. In order to decelerate the movement of the container-receiving device 3b, the damping device 17b has a rotation damper 18b. The rotation damper 18b is arranged concentrically on the drive shaft 21b and thus causes damping of a rotational speed of the drive shaft 21b. Depending on the displacement direction of the container-receiving device 3b, the rotation damper 18b is supported on the racks 23b at any rate indirectly, namely via the drive shaft 21b and the drive pinions 22b.

As a further difference from the armrest arrangements 2, 2a, the armrest arrangement 2b additionally has at least one tolerance-compensating element 26. The at least one tolerance-compensating element 26 serves to compensate for manufacturing- and/or assembly-related shape and/or position tolerances between the container-receiving device 3b and the rest carrier structure 13b. Thus, the container-receiving device 3b is elastically supported at least indirectly on the rest carrying structure 13b transversely to the pull-out direction L by means of the at least one tolerance-compensating element 26. For this purpose, in the present case, there are provided a plurality of tolerance-compensating elements 26 which are each arranged at the end face sides of the guide rods 14 and secured in the radial direction between an outer circumference of the guide rods 14 and an inner circumference of the corresponding retaining portion 15. In this way there is produced, in the radial direction, a floating mounting of the guide rods 14 on the rest carrier structure 13b. As a result of this floating mounting of the guide rods 14, the above-described elastic support of the container-receiving device 3b on the rest carrier structure 13b is obtained.

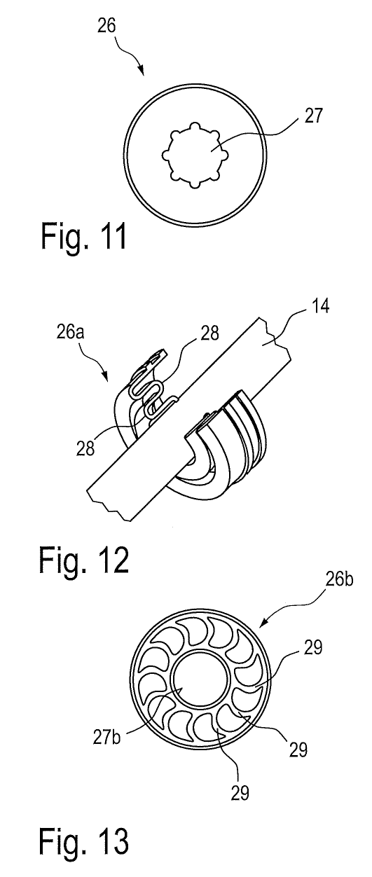

In the present case, the tolerance-compensating elements are produced from plastic and designed in the form of a soft elastic ring 26. This is visible from FIG. 11. The soft elastic ring 26 has a through-hole 27 which is tailored in terms of dimensions to an outer circumference of the guide rod 14. In the present case, the soft elastic ring 26 is produced from PU soft foam.

It will be understood that the tolerance compensation thus produced is not limited to the embodiment according to FIGS. 9 and 10. Rather, such a tolerance compensation can also readily be provided in a corresponding manner in the case of the armrest arrangements 2, 2a.

Alternatively configured tolerance-compensating elements 26a, 26b can be seen from FIG. 12 and FIG. 13. The tolerance-compensating element 26a is designed in the form of an annular membrane having multiple bulges in the axial direction. As a result of the bulges 28, the tolerance-compensating element 26a is elastically flexible in the radial direction. In this respect, the tolerance-compensating element 26a has an elastically flexibly configured design. In other words: the soft elastic configuration of the tolerance-compensating element 26a is substantially structure-related. In addition, the tolerance-compensating element 26a can be produced from a soft elastic material, such as, for example, rubber or the like.

The tolerance-compensating element 26b is configured in the manner of a spoked wheel. The inner circumference 27b of the tolerance-compensating element 26b is in turn tailored to an outside diameter of the guide rod 14. The inner circumference 27b is elastically supported in relation to an outer circumference 30 by means of a plurality of spoke portions 29. The spoke portions 29 each have a profile which is curved with respect to a radial direction. In addition to the thus produced structure-related flexibility of the tolerance-compensating element 26b, the latter can be produced from a flexible and preferably soft elastic material.

1. Armrest arrangement for a vehicle interior having an armrest, a container-receiving device which is provided for receiving a container and arranged at least partially in a cavity of the armrest, and a guide device by means of which the container-receiving device is guided relative to the cavity along a pull-out direction between a retracted inoperative position and an extended receiving position, wherein the guide device is formed on a rest carrier structure which is provided for supporting the armrest and mounted securely on the vehicle in the assembled state.

2. Armrest arrangement according to claim 1, wherein the guide device is a linear guide device by means of which the container-receiving device is guided in a linearly movable manner.

3. Armrest arrangement according to claim 1, wherein the guide device has at least one guide rod which is fastened to the rest carrier structure and on which a guide carriage of the container-receiving device is supported in a linearly displaceable manner.

4. Armrest arrangement according to claim 1, wherein a drive device which is supported on the rest carrier structure is provided by means of which the container-receiving device is displaceable in a driven manner at least from the inoperative position into the receiving position.

5. Armrest arrangement according to claim 4, wherein the drive device has a rack drive having a drive shaft, at least one drive pinion and at least one rack.

6. Armrest arrangement according to claim 1, wherein a damping device which is supported on the rest carrier structure is provided by means of which a displacement speed of the container-receiving device along the pull-out direction is damped.

7. Armrest arrangement according to claim 6, wherein the damping device has a rotation damper which is supported at least indirectly on a rack.

8. Armrest arrangement according to claim 7, wherein the rotation damper is arranged concentrically on the drive shaft of the drive device and causes damping of a rotational speed of the drive shaft.

9. Armrest arrangement according to claim 1, wherein the guide device has at least one tolerance-compensating element by means of which the container-receiving device is elastically supported at least indirectly on the rest carrier structure transversely to the pull-out direction.

10. Armrest arrangement according to claim 9, wherein the tolerance-compensating element is produced from plastic and designed in the form of a soft elastic ring.
